(19) United States
(12) Patent Application Publication
(10) Pub. No.: US 2018/0121311 A1
(43) Pub. Date: May 3, 2018

(54) IDENTIFYING REQUEST-LEVEL CRITICAL PATHS IN MULTI-PHASE PARALLEL TASKS

(71) Applicant: LinkedIn Corporation, Mountain View, CA (US)

(72) Inventors: Jiayu Gong, Fremont, CA (US); Xiaohui Long, Sammamish, WA (US); Wing H. Li, San Jose, CA (US); Joel D. Young, Milpitas, CA (US)

(73) Assignee: LinkedIn Corporation, Mountain View, CA (US)

(21) Appl. No.: 15/337,554

(22) Filed: Oct. 28, 2016

(51) Int. Cl. G06F 11/34; G06F 9/48; G06F 11/30

(52) U.S. Cl. CPC G06F 11/3495; G06F 9/4843; G06F 11/3404; G06F 11/3024; G06F 11/3017

(57) ABSTRACT

The disclosed embodiments provide a system for processing data. During operation, the system obtains a set of latencies for a set of requests in a multi-phase parallel task. Next, the system includes the latencies in a graph-based representation of the multi-phase parallel task. The system then analyzes the graph-based representation to identify a set of high-latency paths in the multi-phase parallel task. Finally, the system uses the set of high-latency paths to output an execution profile for the multi-phase parallel task, wherein the execution profile includes a subset of the requests associated with the high-latency paths.

### RELATED APPLICATION

The subject matter of this application is related to the subject matter in a co-pending non-provisional application by inventors Antonin Steinhauser, Alan Li, Jiayu Gong, Xiaohui Long and Joel Young and filed on the same day as the instant application, entitled “Automatically Detecting Latency Bottlenecks in Asynchronous Workflows,” having serial number TO BE ASSIGNED, and filing date TO BE ASSIGNED (Attorney Docket No. LI-P2194.LNK.US).

### BACKGROUND

### Field

The disclosed embodiments relate to monitoring performance of workflows in computer systems. More specifically, the disclosed embodiments relate to techniques for identifying request-level critical paths in multi-phase parallel tasks.

### Related Art

Web performance is important to the operation and success of many organizations. In particular, a company with an international presence may provide websites, web applications, mobile applications, databases, content, and/or other services or resources through multiple data centers around the globe. An anomaly or failure in a server or data center may disrupt access to a service or a resource, potentially resulting in lost business for the company and/or a reduction in consumer confidence that results in a loss of future business. For example, high latency in loading web pages from the company's website may negatively impact the user experience with the website and deter some users from returning to the website.

The distributed nature of web-based resources may complicate the accurate detection and analysis of web performance anomalies and failures. For example, the overall performance of a website may be affected by the interdependent and/or asynchronous execution of multiple services that provide data, images, video, user-interface components, recommendations, and/or features used in the website. As a result, aggregated performance metrics such as median or average page load times and/or latencies in the website may be calculated and analyzed without factoring in the effect of individual components or services on the website's overall performance.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the generation of an execution profile for an exemplary multi-phase parallel task in accordance with the disclosed embodiments.

FIG. 4A shows an exemplary graph-based representation of execution in an asynchronous workflow in accordance with the disclosed embodiments.

FIG. 4B shows the updating of an exemplary graph-based representation of execution in an asynchronous workflow in accordance with the disclosed embodiments.

FIG. 5 shows a flowchart illustrating the process of analyzing the performance of a multi-phase parallel task in accordance with the disclosed embodiments.

FIG. 6 shows a flowchart illustrating the process of analyzing the performance of an asynchronous workflow in accordance with the disclosed embodiments.

FIG. 7 shows a flowchart illustrating the process of updating a graph-based representation of execution in an asynchronous workflow with a set of causal relationships in accordance with the disclosed embodiments.

FIG. 8 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

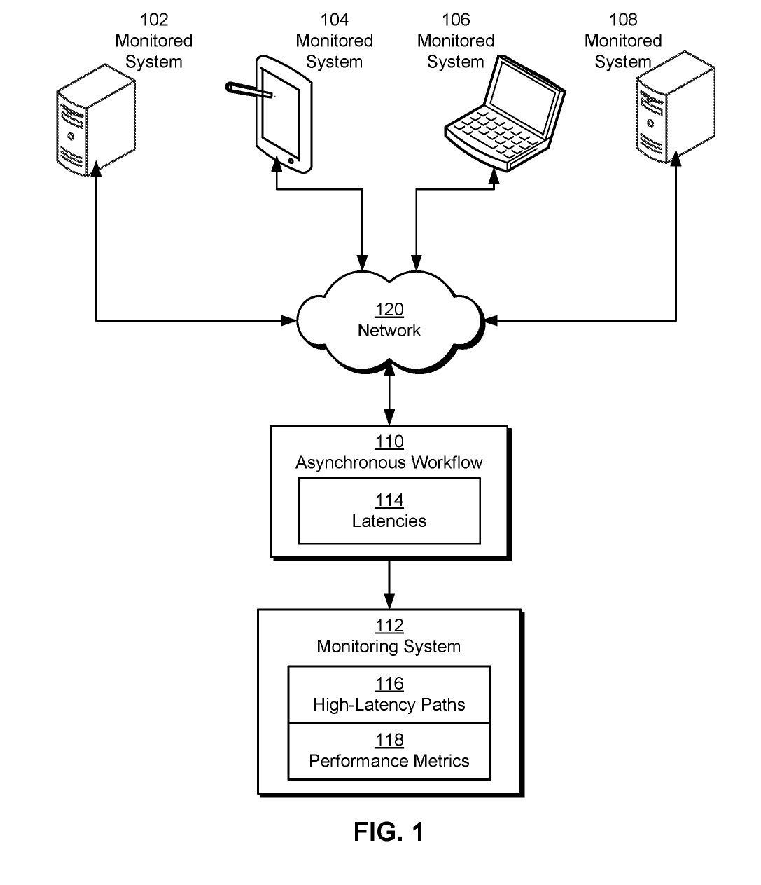

The disclosed embodiments provide a method, apparatus, and system for processing data and improving execution of computer systems. More specifically, the disclosed embodiments provide a method, apparatus, and system for analyzing performance data collected from a monitored system, which may be used to increase or otherwise modify the performance of the monitored system. As shown in FIG. 1, a monitoring system 112 may monitor latencies 114 related to access to and/or execution of an asynchronous workflow 110 by a number of monitored systems 102-108. For example, the asynchronous workflow may be executed by a web application, one or more components of a mobile application, one or more services, and/or another type of client-server application that is accessed over a network 120. In turn, the monitored systems may be personal computers (PCs), laptop computers, tablet computers, mobile phones, portable media players, workstations, servers, gaming consoles, and/or other network-enabled computing devices that are capable of executing the application in one or more forms.

In one or more embodiments, asynchronous workflow 110 combines parallel and sequential execution of tasks. For example, the asynchronous workflow may include a multi-phase parallel task with a number of sequential execution phases, with some or all of the phases composed of a number of tasks that execute in parallel. Alternatively, the asynchronous workflow may have arbitrary causality relations among asynchronous tasks instead of clearly defined execution phases. Thus, the overall latency of the asynchronous workflow may be affected by the structure of the asynchronous workflow and the latencies of individual tasks in the asynchronous workflow, which can vary with execution conditions (e.g., workload, bandwidth, resource availability, etc.) associated with the tasks.

During execution of asynchronous workflow 110, monitored systems 102-108 may provide latencies 114 associated with processing requests, executing tasks, and/or other types of processing or execution to monitoring system 112 for subsequent analysis by the monitoring system. For example, a computing device that retrieves one or more pages (e.g., web pages) or screens of an application over network 120 may transmit load times of the pages or screens to the application and/or monitoring system.

In addition, one or more monitored systems 102-108 may be monitored indirectly through latencies 114 reported by other monitored systems. For example, the performance of a server and/or data center may be monitored by collecting page load times, latencies, error rates, and/or other performance metrics 118 from client computer systems, applications, and/or services that request pages, data, and/or application components from the server and/or data center.

Latencies 114 from monitored systems 102-108 may be aggregated by asynchronous workflow 110 and/or other monitored systems, such as one or more servers used to execute the asynchronous workflow. For example, latencies 114 may be obtained from traces of the asynchronous workflow, which are generated by instrumenting requests, calls, and/or other types of execution in the asynchronous workflow. The latencies may then be provided to monitoring system 112 for the calculation of additional performance metrics 118 and/or identification of high-latency paths 116 in the asynchronous workflow, as described in further detail below.

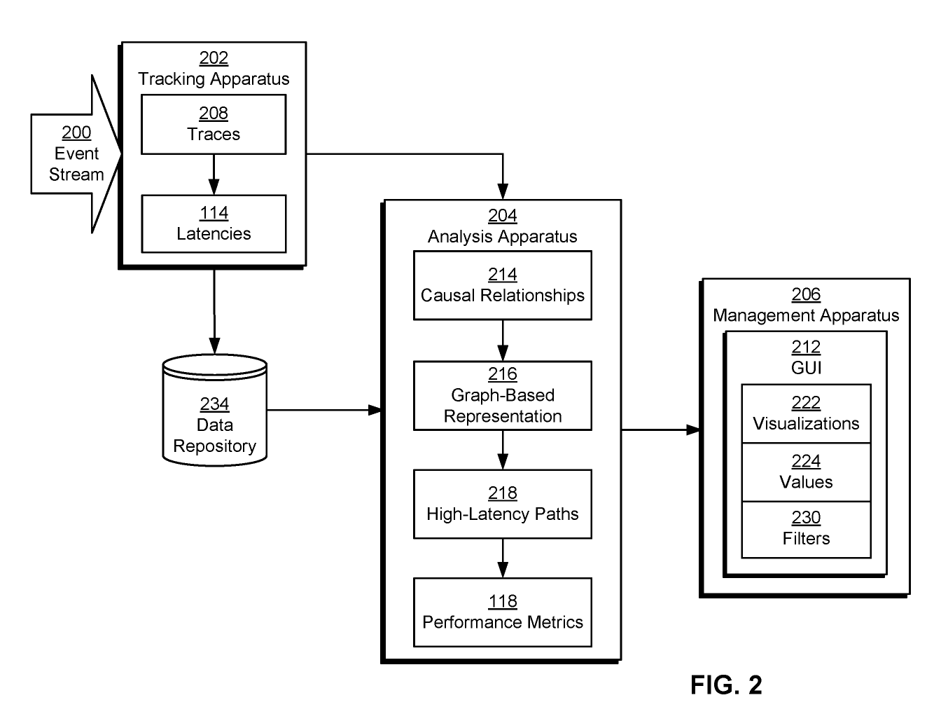

FIG. 2 shows a system for processing data in accordance with the disclosed embodiments. More specifically, FIG. 2 shows a monitoring system, such as monitoring system 112 of FIG. 1, that collects and analyzes performance data from a number of monitored systems. As shown in FIG. 2, the monitoring system includes a tracing apparatus 202, an analysis apparatus 204, and a management apparatus 206. Each of these components is described in further detail below.

Tracing apparatus 202 may generate and/or obtain a set of traces 208 of an asynchronous workflow, such as asynchronous workflow 110 of FIG. 1. For example, the tracing apparatus may obtain the traces by instrumenting requests, calls, and/or other units of execution in the asynchronous workflow. In turn, the traces may be used to obtain a set of latencies 114 associated with processing requests, executing tasks, and/or performing other types of processing or execution in the asynchronous workflow. For example, each trace may provide a start time and an end time for each monitored request, task, and/or other unit of execution in the asynchronous workflow. In turn, the latency of the unit may be obtained by subtracting the end time from the start time.

Alternatively, latencies 114 may be obtained using other mechanisms for monitoring the asynchronous workflow. For example, start times, end times, and/or other measurements associated with the latencies may be obtained from records of activity and/or events in the asynchronous workflow. The records may be provided by servers, data centers, and/or other components used to execute the asynchronous workflow and aggregated to an event stream 200 for further processing by tracing apparatus 202 and/or another component of the system. In turn, the component may process the records by subscribing to different types of events in the event stream and/or aggregating records of the events along dimensions such as location, region, data center, workflow type, workflow name, and/or time interval.

Tracing apparatus 202 may then store traces 208 and/or latencies 114 in a data repository 234, such as a relational database, distributed filesystem, and/or other storage mechanism, for subsequent retrieval and use. A portion of the aggregated records and/or performance metrics may be transmitted directly to analysis apparatus 204 and/or another component of the system for real-time or near-real-time analysis by the component.

In one or more embodiments, metrics and dimensions associated with event stream 200, traces 208, and/or latencies 114 are associated with user activity at a social network such as an online professional network. The online professional network may allow users to establish and maintain professional connections; list work and community experience; endorse, follow, message, and/or recommend one another; search and apply for jobs; and/or engage in other professional or social networking activity. Employers may list jobs, search for potential candidates, and/or provide business-related updates to users.

The online professional network may also display a content feed containing information that may be pertinent to users of the online professional network. For example, the content feed may be displayed within a website and/or mobile application for accessing the online professional network. Updates in the content feed may include posts, articles, scheduled events, impressions, clicks, likes, dislikes, shares, comments, mentions, views, updates, trending updates, conversions, and/or other activity or content by or about various entities (e.g., users, companies, schools, groups, skills, tags, categories, locations, regions, etc.). The feed updates may also include content items associated with the activities, such as user profiles, job postings, user posts, status updates, messages, sponsored content, event descriptions, articles, images, audio, video, documents, and/or other types of content from the content repository.

As a result, traces 208 and latencies 114 may be generated for workflows related to accessing the online professional network. For example, the traces may be used to monitor and/or analyze the performance of asynchronous workflows for generating job and/or connection recommendations, the content feed, and/or other components or features of the online professional network.

After latencies 114 are produced from traces 208, analysis apparatus 204 may produce an execution profile for the asynchronous workflow using the latencies and/or a graph-based representation 216 of the asynchronous workflow. The graph-based representation may include a directed acyclic graph (DAG) and/or graph-based model of execution in the asynchronous workflow. For example, the DAG may include nodes and directed edges that represent the ordering and/or execution of tasks in the asynchronous workflow.

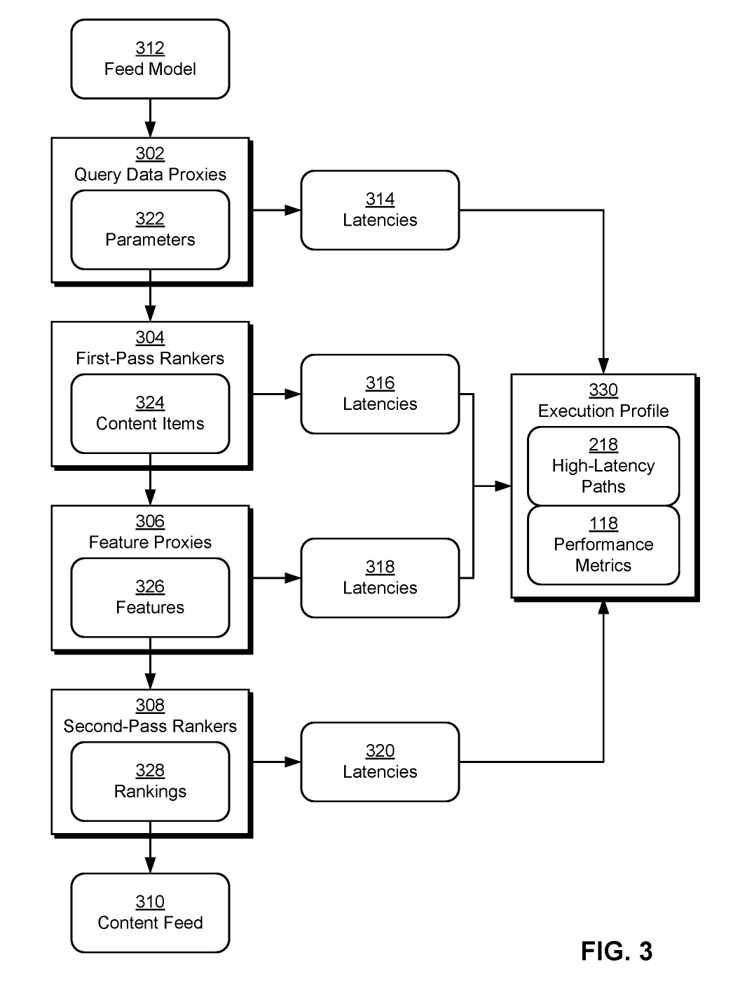

Graph-based representation 216 may be produced by developers, architects, administrators, and/or other users associated with creating or deploying the asynchronous workflow. For example, the graph-based representation may model the execution of a multi-phase parallel task for generating a content feed, as described in further detail below with respect to FIG. 3. In turn, the users may trigger generation of traces 208 of the multi-phase parallel task by manually instrumenting portions of the multi-phase parallel task according to the ordering and/or layout of parallel and sequential requests in the multi-phase parallel task.

Conversely, analysis apparatus 204 may automatically produce graph-based representation 216 from traces 208, latencies 114, and/or other information collected during execution of the asynchronous workflow. For example, the analysis apparatus may include functionality to automatically produce a DAG from any workflow that can be instrumented to provide start and end times of tasks in the workflow and causal relationships 214 among the tasks. Such automatic generation of DAGs from trace information for workflows may allow subsequent analysis and improvement of performance in the workflows to be conducted without requiring manual instrumentation and/or thorough knowledge or analysis of the architecture or execution of the workflows.

In one or more embodiments, causal relationships 214 include predecessor-successor relationships and parent-child relationships. A predecessor-successor relationship may be established between two tasks when one task (e.g., a successor task) begins executing after the other task (e.g., a predecessor task) stops executing. A parent-child relationship may exist between two tasks when one task (e.g., a parent task) calls and/or triggers the execution of another task (e.g., a child task). Because the parent task cannot complete execution until the child task has finished, the latency of the parent task may depend on the latency of the child task.

Causal relationships 214 may be identified in traces 208 of the workflow and used to produce and/or update graph-based representation 216. For example, tracing apparatus 202 may include functionality to produce, as part of a trace, a DAG of an asynchronous workflow from the start times, end times, and/or causal relationships recorded during execution of the asynchronous workflow. The causal relationships may be tracked by a master thread in the asynchronous workflow, and the start and end times of each task may be recorded by the task. Nodes in the DAG may represent tasks in the asynchronous workflow, and directed edges between the nodes may represent causal relationships between the tasks.

Alternatively, one or more causal relationships may be inferred by the tracing apparatus, analysis apparatus 204, and/or another component of the system based on start times, end times, and/or other information in the traces. For example, the component may infer a predecessor-successor relationship between two tasks when one task consistently begins immediately after another task ends. In another example, the component may infer a parent-child relationship between two tasks when the start and end times of one task consistently fall within the start and end times of another task. The inferred causal relationships may then be added to a DAG of the asynchronous workflow.

Analysis apparatus 204 may also update graph-based representation 216 based on causal relationships 214 and/or latencies 114. First, the analysis apparatus may remove tasks that lack start and/or end times in traces 208 from a DAG and/or other graph-based representation of the asynchronous workflow. The analysis apparatus may also remove edges representing potential predecessor-successor relationships, potential parent-child relationships, and/or other causally irrelevant or uncertain relationships from the DAG. Conversely, analysis apparatus 204 may add edges representing inferred causal relationships 214 to the DAG, if the edges are missing.

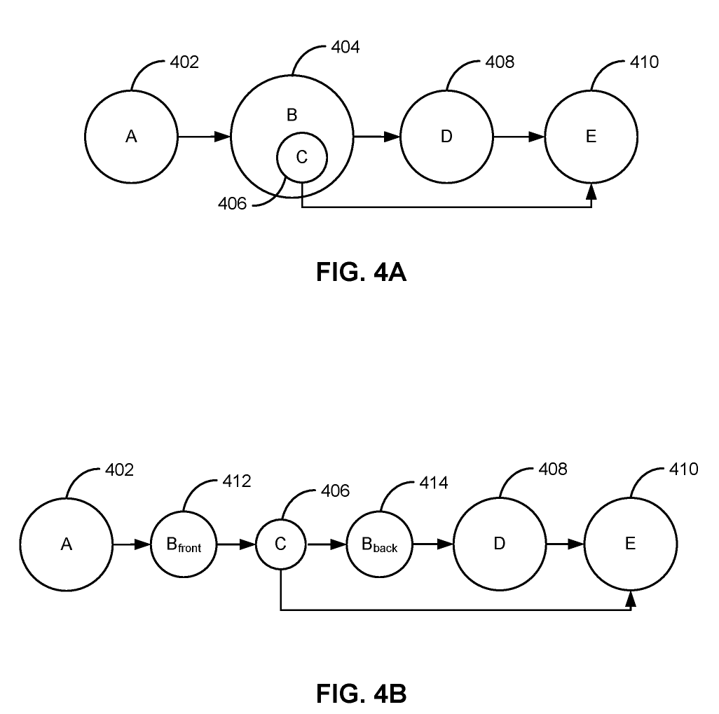

Second, analysis apparatus 204 may convert parent-child relationships in traces 208 and/or graph-based representation 216 into predecessor-successor relationships. In particular, the analysis apparatus may separate a parent task into a front task and a back task. The start of the front task may be set to the start of the parent task and end at the start of the child task. The back task may start with the end of the child task and end with the end of the parent task. Thus, the parent-child relationship may be transformed into a path that includes the front task, followed by the child task, and subsequently followed by the back task. A predecessor task of the parent task may additionally be placed before the front task in the path, and a successor task of the parent task may be placed after the back task in the path. A higher parent task of the parent task may further be set as the parent of both the front and back tasks for subsequent conversion of parent-child relationships between the higher parent task and front task and the higher parent task and back task into predecessor-successor relationships. Converting parent-child relationships into predecessor-successor relationships in graph-based representations of asynchronous workflows is described in further detail below with respect to FIG. 4.

After graph-based representation 216 is generated and/or updated based on causal relationships 214, analysis apparatus 204 may use the graph-based representation to identify a set of high-latency paths 218 in the asynchronous workflow. Each high-latency path may represent a path that contributes significantly to the overall latency of the asynchronous workflow. For example, the high-latency paths may include a critical path for each trace, which is calculated using a topological sort of a DAG representing the asynchronous workflow. In the topological sort, the task with the highest end time may represent the end of the critical path. Directed edges that directly or indirectly connect the task with other tasks in the DAG may then be traversed in reverse until a start task with no predecessors is found. In turn, the critical path may be constructed from all tasks on the longest (e.g., most time-consuming) path between the start and end.

In another example, analysis apparatus 204 may first identify the highest-latency request in a first phase of a multi-phase parallel task, and then identify the highest-latency request in a second phase of the multi-phase parallel task that is on the same path as the highest-latency request in the first phase. The analysis apparatus may include the path in the set of high-latency paths 218 for the multi-phase parallel task. The analysis apparatus may generate another high-latency path from the second-slowest request in the first phase and the second-slowest request in the second phase that is on the same path as the second-slowest request in the first phase. As a result, high-latency paths for the multi-phase parallel task may include the slowest path and the second-slowest path in the multi-phase parallel task. Generating high-latency paths for multi-phase parallel tasks is described in further detail below with respect to FIG. 3.

After high-latency paths 218 are calculated, analysis apparatus 204 may calculate performance metrics 118 for the high-latency paths. The performance metrics may include a frequency of occurrence of a task in the high-latency paths, such as the percentage of time a given task is found in the critical (e.g., slowest) path, second-slowest path, and/or another type of high-latency path in the asynchronous workflow. The performance metrics may also include statistics such as a maximum, percentile, mean, and/or median associated with latencies 114 for individual tasks. The performance metrics may further include a change in a given statistic over time, such as a week-over-week change in the maximum, percentile, mean, and/or median.

Performance metrics 118 may additionally include a potential improvement associated with a task in a high-latency path of a multi-phase parallel task. The potential improvement may be calculated by obtaining a first statistic (e.g., maximum, percentile, median, mean, etc.) associated with the slowest request in a given phase of the multi-phase parallel task and a second statistic associated with the second-slowest request in the phase, and then multiplying the difference between the two statistics with the frequency of occurrence of the slowest request. In other words, the potential improvement may represent the “expected value” of the reduction in latency associated with improving the performance of the slowest request.

After high-latency paths 218 and performance metrics 118 are produced by analysis apparatus 204, management apparatus 206 may output, in a graphical user interface (GUI) 212, one or more representations of an execution profile containing the high-latency paths and/or performance metrics. First, management apparatus 206 may display one or more visualizations 222 in GUI 212. The visualizations may include charts of aggregated performance metrics for one or more tasks and/or high-latency paths in the asynchronous workflow. For example, the charts may include, but are not limited to, line charts, bar charts, waterfall charts, and/or scatter plots of the performance metrics along different dimensions or combinations of dimensions. The visualizations may also include graphical depictions of the high-latency paths and/or performance metrics. For example, the visualizations may include a graphical representation of a DAG for the asynchronous workflow. Within the graphical representation, one or more high-latency paths may be highlighted, colored, and/or otherwise visually distinguished from other paths in the DAG. Latencies of tasks in the high-latency paths and/or other parts of the DAG may also be displayed within and/or next to the corresponding nodes in the DAG.

Second, management apparatus 206 may display one or more values 224 associated with performance metrics 118 and/or high-latency paths 218 in GUI 212. For example, management apparatus 206 may display a list, table, overlay, and/or other user-interface element containing the performance metrics and/or tasks in the high-latency paths. Within the user-interface element, the values may be sorted in descending order of latency, so that tasks with the highest latency appear at the top and tasks with the lowest latency appear at the bottom. The values may also be sorted in descending order of potential improvement to facilitate identification of requests and/or tasks that can provide the best improvements to the overall latency of the asynchronous workflow. Management apparatus 206 may also provide recommendations related to modifying the execution of the asynchronous workflow, processing of requests in the asynchronous workflow, including or omitting tasks or requests in the asynchronous workflow, and/or otherwise modifying or improving the execution of the asynchronous workflow.

To facilitate analysis of charts 222 and/or values 224, management apparatus 206 may provide one or more filters 230. For example, management apparatus 206 may display filters 230 for various dimensions associated with performance metrics 118 and/or high-latency paths 218. After one or more filters are selected by a user interacting with GUI 212, the management apparatus 206 may use filters 230 to update visualizations 222 and/or values 224. For example, the management apparatus may update the visualizations and/or values to reflect the grouping, sorting, and/or filtering associated with the selected filters. Consequently, the system of FIG. 2 may improve the monitoring, assessment, and management of requests and/or other tasks in asynchronous workflows.

Those skilled in the art will appreciate that the system of FIG. 2 may be implemented in a variety of ways. As mentioned above, an “online” instance of analysis apparatus 204 may perform real-time or near-real-time processing of traces 208 to identify the most recent high-latency paths 218 and/or performance metrics 118 associated with the asynchronous workflow, and an “offline” instance of the analysis apparatus may perform batch or offline processing of the traces. A portion of the analysis apparatus may also execute in the monitored systems to produce the high-latency paths and/or performance metrics from local traces, in lieu of or in addition to producing execution profiles from traces received from the monitored systems.

Similarly, tracing apparatus 202, analysis apparatus 204, management apparatus 206, GUI 212, and/or data repository 234 may be provided by a single physical machine, multiple computer systems, one or more virtual machines, a grid, a cluster, one or more databases, one or more filesystems, and/or a cloud computing system. Tracing apparatus 202, analysis apparatus 204, GUI 212, and management apparatus 206 may additionally be implemented together and/or separately by one or more hardware and/or software components and/or layers.

Moreover, a variety of techniques may be used to produce graph-based representation 216, high-latency paths 218, and/or performance metrics 118 for the asynchronous workflow. For example, analysis apparatus 204 may include functionality to produce and/or update the graph-based representation based on other types of causal relationships 214 by translating the causal relationships into sets of predecessor-successor relationships in the graph-based representation. In another example, the high-latency paths may be constructed from different combinations and/or orderings of tasks associated with high latency in the asynchronous workflow, such as tasks in a third-slowest path in the asynchronous workflow and/or paths formed from high-latency requests in a multi-phase parallel task that are selected from different orderings of phases in the multi-phase parallel task.

FIG. 3 shows the generation of an execution profile 330 for an exemplary multi-phase parallel task in accordance with the disclosed embodiments. As mentioned above, the multi-phase parallel task may be used to generate a content feed 310 containing an ordering of content items 324 such as user profiles, job postings, user posts, status updates, messages, sponsored content, event descriptions, articles, images, audio, video, documents, and/or other types of content. For example, the multi-phase parallel task may be used to customize the content feed to the attributes, behavior, and/or interests of members or related groups of members (e.g., connections, follows, schools, companies, group activity, member segments, etc.) in a social network and/or online professional network.

In addition, the multi-phase parallel task may include a sequence of distinct phases, with one or more phases containing a set of requests executing in parallel. As shown in FIG. 3, the multi-phase parallel task may begin with a phase that retrieves a feed model 312 of requests to be processed in the multi-phase parallel task. The feed model may be customized to include new and/or different types of recommendations, content, scoring techniques, and/or other factors associated with generating content feed 310. In turn, different feed models may be used to adjust the execution of the multi-phase parallel task and/or the composition of the content feed. For example, one feed model may be used to produce a “news feed” of articles and/or other recently published content, another feed model may be used to generate a content feed containing published content and/or network updates for the homepage of a mobile application used to access a social network, and a third feed model may be used to generate the content feed for the homepage of a web application used to access the social network. In another example, newer feed models may be created to produce content feeds from newer statistical models, recommendation techniques, and/or sets of parameters 322 and/or features 326 used by the statistical models or recommendation techniques.

Feed model 312 may be used to call a set of query data proxies 302 in a second phase of the multi-phase parallel task. Each query data proxy may retrieve a set of parameters 322 used by a set of first-pass rankers 304 in a third phase of the multi-phase parallel task to select and/or rank sets of content items 324 for inclusion in content feed 310. For example, the query data proxies may obtain parameters related to a member of a social network, such as the member's connections, followers, companies, groups, connection strengths, recent behavior (e.g., clicks, comments, views, shares, likes, dislikes, etc.), demographic attributes, and/or profile data. In addition, each query data proxy may retrieve a different set of parameters 322. Continuing with the previous example, one query data proxy may retrieve the member's connections in the social network, and another query data proxy may obtain the member's recent activity with the social network.

Different first-pass rankers 304 may depend on parameters 322 from different query data proxies 302. For example, a ranker that selects content items 324 containing feed updates from a member's connections, follows, groups, companies, and/or schools in a social network may execute using parameters related to the member's connections, groups, follows, companies, and/or schools in the social network. On the other hand, a ranker that selects job listings for recommendation to the member in content feed 310 may use parameters related to the member's profile, employment history, skills, reputation, and/or seniority. Consequently, a given first-pass ranker may begin executing after all query data proxies supplying parameters to the first-pass ranker have completed execution, which may result in staggered start and end times of the first-pass rankers in the third phase.

After first-pass rankers 304 have generated sets of content items 324 for inclusion in content feed 310, a set of feature proxies 306 may execute in a fourth phase to retrieve sets of features 326 used by a set of second-pass rankers 308 in a fifth phase to produce rankings 328 and/or scoring of the content items. For example, the features may be used by statistical models in the second-pass rankers to score the content items by relevance to the member. Thus, relevance scores produced by the second-pass rankers may be based on features representing recent activities and/or interests of the member; profile data and/or member segments of the member; user engagement with the feed updates within the member segments, the member's connections, and/or the social network; editorial input from administrative users associated with creating or curating content in the content feed; and/or sources of the content items. The relevance scores may also, or instead, include estimates of the member's probability of clicking on or otherwise interacting with the corresponding feed updates. As with use of parameters 322 by first-pass rankers 304, a given second-pass ranker may begin executing after all feature proxies supplying features to the ranker have finished executing.

After second-pass rankers 308 have completed execution, rankings 328 of content items 324 from the second-pass rankers may be used to generate content feed 310. For example, the second-pass rankers may rank the content items by descending order of relevance score and/or estimated click probability for a member of a social network, so that feed updates at the top of the ranking are most relevant to or likely to be clicked by the member and feed updates at the bottom of the ranking are least relevant to or likely to be clicked by the member. During generation of content feed 310, impression discounting may be applied to reduce the score and/or estimated click probability of a content item based on previous impressions of the content item by the member. Similarly, the scores of a set of content items from a given first-pass ranker may be decreased if the content items have been viewed more frequently than content items from other first-pass rankers. De-duplication of content items in the content feed may also be performed by aggregating a set of content items shared by multiple users and/or a set of content items with similar topics into a single content item in the content feed.

An execution profile 330 for the multi-phase parallel task may be generated from latencies 314-320 associated with query data proxies 302, first-pass rankers 304, features proxies 306, and/or second-pass rankers 308. As described above, the latencies may be calculated using the start and end times of the corresponding tasks, which may be obtained from traces of the multi-phase parallel task.

More specifically, a set of high-latency paths 218 in the multi-phase parallel task may be identified using latencies 314-320 and a graph-based representation of the multi-phase parallel task. For example, latencies 314-320 may be used to generate performance metrics 118, such as a mean, median, percentile, and/or maximum value of latency for each request in the multi-phase parallel task. Next, a given performance metric associated with latencies 316 (e.g., a 99^{th} percentile) may be used to identify a first-pass ranker with the highest latency among all first-pass rankers 304. The same performance metric for latencies 314 may then be used to identify, from a subset of query data proxies on which the first-pass ranker depends, a query data proxy with the highest latency. The process may optionally be repeated to identify feature proxies 306, second-pass rankers 308, and/or other types of requests with high latency that are on the same path as the first-pass ranker and/or query data proxy. In turn, the identified requests may be used to produce one or more slowest paths in execution profile 330. A similar technique may additionally be used to select requests with the second-highest latencies in various phases of the multi-phase parallel task and construct second-slowest paths that are included in the execution profile.

Performance metrics 118 may also be updated based on high-latency paths 218. For example, the performance metrics may include a frequency of occurrence of a request in the high-latency paths, which may include the percentage of time the request is found in the slowest path and/or second-slowest path. The performance metrics may also include a potential improvement associated with the request, which may be calculated by multiplying the difference between a statistic (e.g., mean, median, percentile, maximum, etc.) calculated from the request's latencies and the same statistic for the second-slowest request by the frequency of occurrence of the request in a high-latency path.

FIG. 4A shows an exemplary graph-based representation of execution in an asynchronous workflow in accordance with the disclosed embodiments. As shown in FIG. 4A, the graph-based representation includes a number of nodes 402-410 and a set of directed edges between the nodes. In the graph-based representation, an edge between nodes 402 and 404 indicates a predecessor-successor relationship between a task “A” and a task “B” that follows “A.” An edge between nodes 404 and 408 represents a predecessor-successor relationship between task “B” and a task “D” that follows task “B.” An edge between nodes 408 and 410 represents a predecessor-successor relationship between task “D” and a task “E” that follows task “D.” An edge between nodes 406 and 410 represents a predecessor-successor relationship between a task “C” and task “E.” Finally, the inclusion of node 406 in node 404 indicates a parent-child relationship between parent task “B” and child task “C.” As a result, the graph-based representation of FIG. 4A may indicate that tasks “A,” “B,” “D” and “E” execute in sequence, task “C” is called or otherwise executed by task “B,” and task “E” executes after task “C.”

FIG. 4B shows the updating of an exemplary graph-based representation of execution in an asynchronous workflow in accordance with the disclosed embodiments. More specifically, FIG. 4B shows the updating of the graph-based representation of FIG. 4A to reflect a transformation of the parent-child relationship between tasks “B” and “C” into a set of predecessor-successor relationships.

In the graph-based representation of FIG. 4B, task “B” has been separated into tasks named “B_{front}” and “B_{back},” which are shown as nodes 412 and 414. Node 412 is placed after node 402, node 414 is placed before node 408, and node 406 is placed between nodes 412 and 414. The start time of “B_{front}” is set to the start of “B,” the end time of “B_{front}” is set to the start time of “C,” the start time of “B_{back}” is set to the end time of “C,” and the end time of “B_{back}” is set to the end of “B.”

In turn, the graph-based representation of FIG. 4B may be used to analyze the individual latencies of tasks in a critical path of the asynchronous workflow, such as the path containing nodes 402, 412, 406, 414, 408, and 410. Because node 404 has been split into two nodes 412 and 414 that are separated by node 406 in the path, the contribution of task “B” to the overall latency in the critical path may be analyzed by summing the latencies of “B_{front}” and “B_{back}.” On the other hand, the latency of task “B” may include the latency of child task “C” when the graph-based representation of FIG. 4A is used to evaluate latencies of individual tasks on the critical path. Consequently, the graph-based representation of FIG. 4B may enable more accurate analysis of latency bottlenecks and/or other performance issues associated with the asynchronous workflow than conventional techniques that do not account for parent-child relationships in workflows.

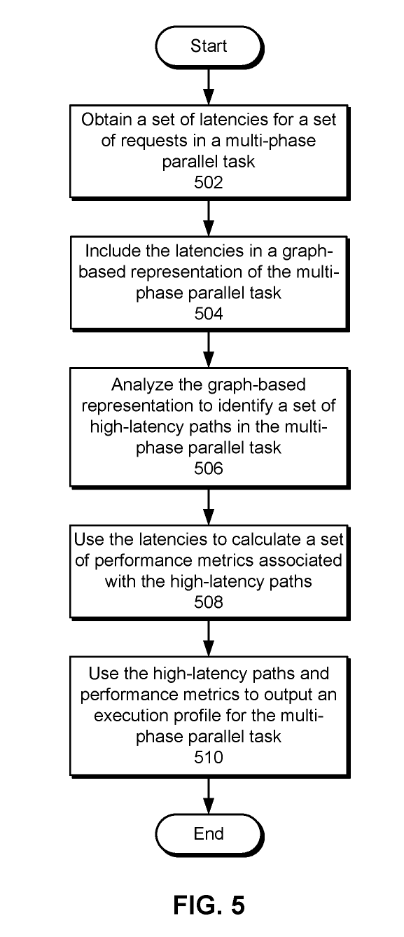

FIG. 5 shows a flowchart illustrating the process of analyzing the performance of a multi-phase parallel task in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, a set of latencies for a set of requests in a multi-phase parallel task is obtained (operation 502). For example, the multi-phase parallel task may be used to generate a ranking of content items in a content feed. As a result, the requests may include a request to a query data proxy for a set of parameters used to generate the content feed, a request to a first-pass ranker for a subset of content items in the content feed, and/or a request to a feature proxy for a set of features used to generate the content feed.

The latencies may be obtained from traces of the requests. For example, each trace may include a start time and end time of the corresponding request. As a result, the latency of the request may be calculated by subtracting the start time from the end time. The latencies are also included in a graph-based representation of the multi-phase parallel task (operation 504). For example, the latencies may be included in a DAG that models the execution of the multi-phase parallel task.

Next, the graph-based representation is analyzed to identify a set of high-latency paths in the multi-phase parallel task (operation 506). The high-latency paths may include a slowest path and/or a second-slowest path in the multi-phase parallel task. For example, a first request with the highest latency in a first phase of the multi-phase parallel task may be identified. For a path containing the first request, a second request with the highest latency in a second phase of the multi-phase parallel task may be identified. The first and second requests may then be included in the slowest path of the multi-phase parallel task. In another example, the first request may have the second-highest latency in the first phase, the second request may have the second-highest latency among requests in the second phase that are on a path containing the first request, and the requests may be included in the second-slowest path of the multi-phase parallel task.

The latencies are then used to calculate a set of performance metrics associated with the high-latency paths (operation 508). The performance metrics may include a frequency of occurrence of a request in the high-latency paths (e.g., the percentage of time the request is found in a slowest and/or second-slowest path), a maximum value associated with latencies of the request, a percentile associated with the latencies, a median associated with the latencies, a change in a performance metric over time, and/or a potential improvement associated with the request. The potential improvement may be calculated by obtaining a first statistic associated with a slowest request in a phase of the multi-phase parallel task and a second statistic associated with a second-slowest request in the same phase, and then multiplying the difference between the first and second statistics by the frequency of occurrence of the slowest request.

Finally, the high-latency paths and performance metrics are used to output an execution profile for the multi-phase parallel task (operation 510). For example, the high-latency paths and/or performance metrics may be displayed within a chart, table, and/or other representation in a GUI; included in reports, alerts, and/or notifications; and/or used to dynamically adjust the execution of the multi-phase parallel task.

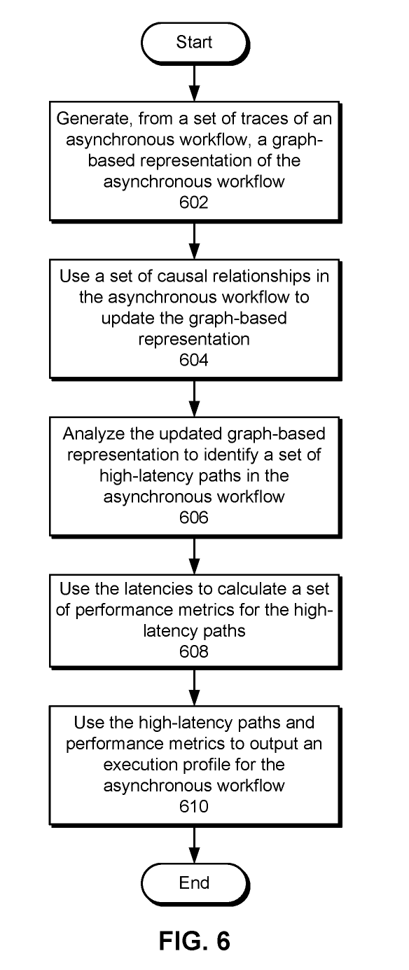

FIG. 6 shows a flowchart illustrating the process of analyzing the performance of an asynchronous workflow in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the technique.

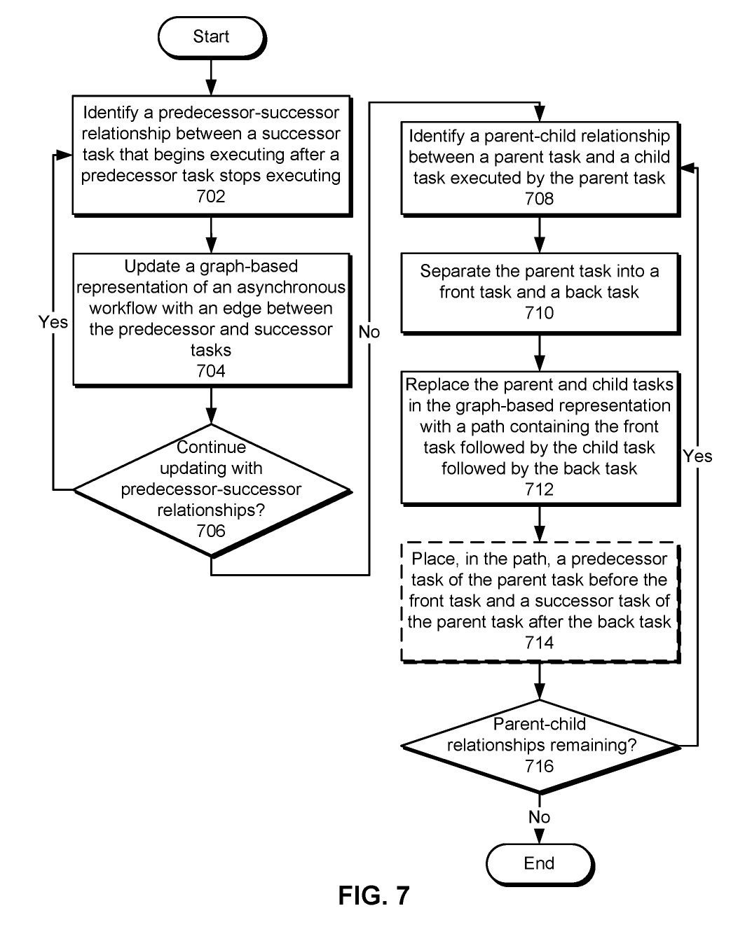

First, a graph-based representation of an asynchronous workflow is generated from a set of traces of the asynchronous workflow (operation 602). For example, the graph-based representation may initially be generated from start times, end times, and/or some causal relationships associated with the tasks in the traces. Next, a set of causal relationships in the asynchronous workflow is used to update the graph-based presentation (operation 604), as described in further detail below with respect to FIG. 7.

The updated graph-based representation is then analyzed to identify a set of high-latency paths in the multi-phase parallel task (operation 606). For example, a topological sort of the updated graph-based representation may be used to identify the high-latency paths as the “longest” paths in the graph-based representation, in terms of overall latency. Finally, the latencies are also used to calculate a set of performance metrics for the high-latency paths (operation 608), and the high-latency paths and performance metrics are used to output an execution profile for the asynchronous workflow (operation 610). For example, the execution profile may include a list of tasks with the highest latency in the high-latency paths, along with performance metrics associated with the tasks.

FIG. 7 shows a flowchart illustrating the process of updating a graph-based representation of execution in an asynchronous workflow with a set of causal relationships in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the technique.

First, a predecessor-successor relationship between a successor task that begins executing after a predecessor task stops executing is identified (operation 702). The predecessor-successor relationship may be identified by a master thread in the asynchronous workflow and/or by analyzing start and end times of tasks in the asynchronous workflow. Next, a graph-based representation of the asynchronous workflow is updated with an edge between the predecessor and successor tasks (operation 704). For example, a DAG of the asynchronous workflow may be updated to include a directed edge from the predecessor task to the successor task. Operations 702-704 may be repeated during updating of the graph-based representation with predecessor-successor relationships (operation 706). For example, predecessor-successor relationships may continue to be identified and added to the graph-based representation until the graph-based representation contains all identified and/or inferred predecessor-successor relationships in the asynchronous workflow.

A parent-child relationship between a parent task and a child task executed by the parent task is also identified (operation 708). To update the graph-based representation based on the parent-child relationship, the parent task is separated into a front task and a back task (operation 710), and the parent and child tasks in the graph-based representation are replaced with a path containing the front task, followed by the child task, followed by the back task (operation 712). A predecessor task of the parent task is placed before the front task, and a successor task of the parent task is placed after the back task (operation 714), if predecessor and/or successor tasks of the parent task exist in the graph-based representation. Operations 708-714 may be repeated for remaining parent-child relationships (operation 716) in the asynchronous workflow.

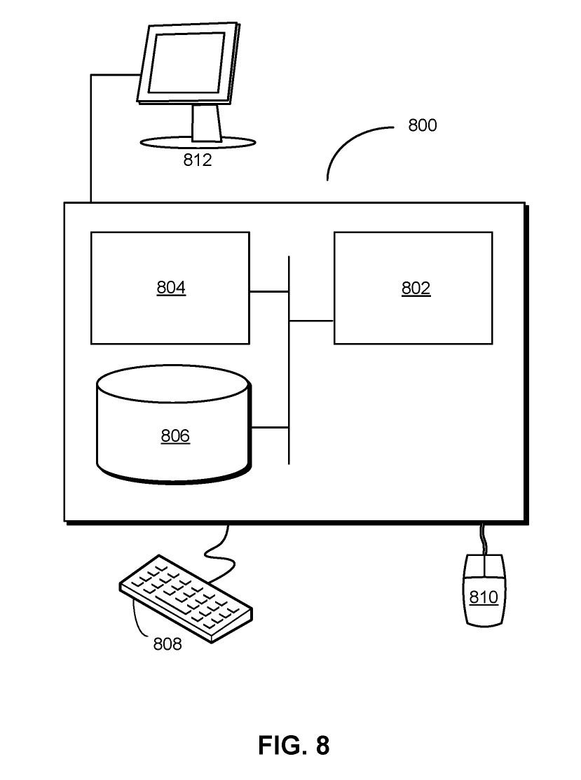

FIG. 8 shows a computer system in accordance with the disclosed embodiments. Computer system 800 may correspond to an apparatus that includes a processor 802, memory 804, storage 806, and/or other components found in electronic computing devices. Processor 802 may support parallel processing and/or multi-threaded operation with other processors in computer system 800. Computer system 800 may also include input/output (I/O) devices such as a keyboard 808, a mouse 810, and a display 812.

Computer system 800 may include functionality to execute various components of the present embodiments. In particular, computer system 800 may include an operating system (not shown) that coordinates the use of hardware and software resources on computer system 800, as well as one or more applications that perform specialized tasks for the user. To perform tasks for the user, applications may obtain the use of hardware resources on computer system 800 from the operating system, as well as interact with the user through a hardware and/or software framework provided by the operating system.

In one or more embodiments, computer system 800 provides a system for processing data. The system may include an analysis apparatus and a management apparatus. The analysis apparatus may obtain a set of latencies for a set of requests in a multi-phase parallel task. Next, the analysis apparatus may include the latencies in a graph-based representation of the multi-phase parallel task. The analysis apparatus may then analyze the graph-based representation to identify a set of high-latency paths in the multi-phase parallel task.

The analysis apparatus may also, or instead, generate a graph-based representation of an asynchronous workflow from a set of traces of the asynchronous workflow. Next, the analysis apparatus may use a set of causal relationships in the asynchronous workflow to update the graph-based representation. The analysis apparatus may then analyze the updated graph-based representation to identify a set of high-latency paths in the asynchronous workflow.

The analysis apparatus may additionally use the set of latencies to calculate a set of performance metrics associated with the high-latency paths for the multi-phase parallel task and/or asynchronous workflow. The management apparatus may then use the set of high-latency paths to output an execution profile, which includes a subset of tasks associated with the high-latency paths in the asynchronous workflow and/or multi-phase parallel task. The management apparatus may also include the performance metrics in the outputted execution profile.

In addition, one or more components of computer system 800 may be remotely located and connected to the other components over a network. Portions of the present embodiments (e.g., analysis apparatus, management apparatus, tracing apparatus, data repository, etc.) may also be located on different nodes of a distributed system that implements the embodiments. For example, the present embodiments may be implemented using a cloud computing system that monitors a set of remote asynchronous workflows and/or multi-phase parallel tasks for performance issues and generates output to facilitate assessment and mitigation of the performance issues.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising;
obtaining a set of latencies for a set of requests in a multi-phase parallel task;
including the latencies in a graph-based representation of the multi-phase parallel task;
analyzing, by a computer system, the graph-based representation to identify a set of high-latency paths in the multi-phase parallel task; and
using the set of high-latency paths to output an execution profile for the multi-phase parallel task, wherein the execution profile comprises a subset of the requests associated with the high-latency paths.

2. The method of claim 1, further comprising:
using the set of latencies to calculate a set of performance metrics associated with the high-latency paths; and
including the performance metrics in the outputted execution profile.

3. The method of claim 2, wherein the set of performance metrics comprises at least one of:
a frequency of occurrence of a request in the high-latency paths;
a maximum value associated with the set of latencies;
a percentile associated with the set of latencies;
a median associated with the set of latencies;
a change in a performance metric over time; and
a potential improvement associated with the request.

4. The method of claim 3, wherein using the set of latencies to calculate the set of performance metrics associated with the high-latency paths comprises:
obtaining a first statistic associated with a slowest request in a phase of the multi-phase parallel task and a second statistic associated with a second-slowest request in the phase; and
calculating the potential improvement associated with the slowest request using a difference between the first and second statistics and the frequency of occurrence of the slowest request in the phase.

5. The method of claim 1, wherein analyzing the graph-based representation to identify the set of high-latency paths in the multi-phase parallel task comprises:
identifying a first request with a highest latency in a first phase of the multi-phase parallel task;
identifying, for a path comprising the first request in the multi-phase parallel task, a second request with the highest latency in a second phase of the multi-phase parallel task; and
including the first and second requests in a high-latency path of the multi-phase parallel task.

6. The method of claim 1, wherein obtaining the set of latencies for the set of requests in the multi-phase parallel task comprises:
for each request in the set of requests, obtaining a start time and an end time from a trace of the request.

7. The method of claim 1, wherein the multi-phase parallel task is used to generate a ranking of content items in a content feed.

8. The method of claim 7, wherein the set of requests comprises:
a request to a query data proxy for a set of parameters used to generate the content feed.

9. The method of claim 7, wherein the set of requests comprises:
a request to a first-pass ranker for a set of content items in the content feed.

10. The method of claim 7, wherein the set of requests comprises:
a request to a feature proxy for a set of features used to generate the content feed.

11. The method of claim 1, wherein the graph-based representation comprises a directed acyclic graph (DAG).

12. The method of claim 1, wherein the set of high-latency paths comprises:
a slowest path in the multi-phase parallel task; and
a second-slowest path in the multi-phase parallel task.

13. An apparatus, comprising:
one or more processors; and
memory storing instructions that, when executed by the one or more processors, cause the apparatus to:
obtain a set of latencies for a set of requests in a multi-phase parallel task;
include the latencies in a graph-based representation of the multi-phase parallel task;
analyze the graph-based representation to identify a set of high-latency paths in the multi-phase parallel task; and
use the set of high-latency paths to output an execution profile for the multi-phase parallel task, wherein the execution profile comprises a subset of the requests associated with the high-latency paths.

14. The apparatus of claim 13, wherein the memory further stores instructions that, when executed by the one or more processors, cause the apparatus to:
use the set of latencies to calculate a set of performance metrics associated with the high-latency paths; and
include the performance metrics in the outputted execution profile.

15. The apparatus of claim 14, wherein the set of performance metrics comprises at least one of:
a frequency of occurrence of a request in the high-latency paths;
a maximum value associated with the set of latencies;
a percentile associated with the set of latencies;
a median associated with the set of latencies;
a change in a performance metric over time; and
a potential improvement associated with the request.

16. The apparatus of claim 15, wherein using the set of latencies to calculate the set of performance metrics associated with the high-latency paths comprises:
obtaining a first statistic associated with a slowest request in a phase of the multi-phase parallel task and a second statistic associated with a second-slowest request in the phase; and
calculating the potential improvement associated with the slowest request using a difference between the first and second statistics and the frequency of occurrence of the slowest request in the phase.

17. The apparatus of claim 13, wherein analyzing the graph-based representation to identify the set of high-latency paths in the multi-phase parallel task comprises:
identifying a first request with a highest latency in a first phase of the multi-phase parallel task;
identifying, for a path comprising the first request in the multi-phase parallel task, a second request with the highest latency in a second phase of the multi-phase parallel task; and
including the first and second requests in a high-latency path of the multi-phase parallel task.

18. The apparatus of claim 13, wherein the set of requests comprises:
a request to a query data proxy for a set of parameters used to generate a content feed;
a request to a first-pass ranker for a set of content items in the content feed; and
a request to a feature proxy for a set of features used to generate the content feed.

19. A system, comprising:
an analysis module comprising a non-transitory computer-readable medium comprising instructions that, when executed, cause the system to:
obtain a set of latencies for a set of requests in a multi-phase parallel task;
include the latencies in a graph-based representation of the multi-phase parallel task;
analyze the graph-based representation to identify a set of high-latency paths in the multi-phase parallel task; and
a management module comprising a non-transitory computer-readable medium comprising instructions that, when executed, cause the system to use the set of high-latency paths to output an execution profile for the multi-phase parallel task, wherein the execution profile comprises a subset of the requests associated with the high-latency paths.

20. The system of claim 19, wherein analyzing the graph-based representation to identify the set of high-latency paths in the multi-phase parallel task comprises:
identifying a first request with a highest latency in a first phase of the multi-phase parallel task;
identifying, for a path comprising the first request in the multi-phase parallel task, a second request with the highest latency in a second phase of the multi-phase parallel task; and
including the first and second requests in a high-latency path of the multi-phase parallel task.
